(19) United States
(12) Patent Application Publication
(10) Pub. No.: US 2008/0199832 A1
(43) Pub. Date: Aug. 21, 2008

(54) GUTTA PERCHA TIP AND METHOD FOR PRODUCING THE SAME

(75) Inventors: Werner Mannschedel, Langenau (DE); Barbar Muller, Langenau (DE)

Correspondence Address: KATTEN MUCHIN ROSENMAN LLP, 575 MADISON AVENUE, NEW YORK, NY, 10022-2585, US

(73) Assignee: COLTENE/WHALEDENT GMBH & CO., KG, Langenau (DE)

(21) Appl. No.: 12/046,661

(22) Filed: Mar. 12, 2008

Related U.S. Application Data
(63) Continuation-in-part of application No. 11/357,000, filed on Feb. 17, 2006, now abandoned.
Application No. 11/357,000 is a continuation of application No. PCT/EP2004/009320, filed on Aug. 19, 2004.

(30) Foreign Application Priority Data
Aug. 19, 2003 (DE) 10338440.5

(51) Int. Cl. A61C 5/02

(52) U.S. Cl. 433/224; 433/81

(57) ABSTRACT

The present invention is concerned with a gutta-percha point for filling a tooth root canal system, which is characterized in that it has a plurality of deformable protrusions formed on a longitudinal surface where the protrusions are constructed in the form of helical winding and have a thickness appropriate to achieve a desired thickness of the sealer.

### CROSS-REFERENCE TO RELATED APPLICATIONS

This application is a continuation-in-part of U.S. patent application Ser. No. 11/357,000, filed Feb. 17, 2006, still pending, which is a continuation of International Application PCT/EP2004/009320 having an International filing date of Aug. 19, 2004, each of which is incorporated herein by reference in their entirety.

### BACKGROUND OF THE INVENTION

### Field of the Invention

The present invention generally relates to dentistry aids. More particularly, the present invention relates to a gutta-percha point for filling a tooth root canal system and a process for preparation of same.

In root canal treatment, a best possible hermetic seal using a filling material that does not irritate the tissue is desirable. The ideal root canal filling material should not irritate the periapical tissue, should tightly occlude the root canal laterally and vertically, should have a stable volume and should not shrink in the root canal. Furthermore, it should not encourage bacterial growth, should be as bacteriostatic as possible, and at the same time be biologically compatible and non-toxic.

It has been shown that root canal filling using gutta-percha points and a sealer is biologically the best and, the safest method in the long term. A distinguishing feature of a gutta-percha point is the thermoplastic deformability of the material, which enables it to be worked well under gentle heat, for example, at body temperature, i.e. 37° C., and, consequently, permits an especially reliable filling of a root canal. Typically, such a gutta-percha point has a gutta-percha content of about 20% by weight ±10% by weight. This differentiates a gutta-percha tip or a gutta-percha point from a retention pin or post. A retention pin or post consists of a solid material, such as, metal or a metal alloy which is anchored in a tooth cavity, for example, in the upper two thirds of a root canal. An example of a use of a retention pin or post is to fix dental prostheses, such as crowns or bridges. Widely used methods for introducing gutta-percha into the root canal are lateral condensation, vertical condensation, thermomechanical condensation and injection techniques.

In lateral condensation, the root canal filling commences with the selection of a gutta-percha master point, which is first introduced into the root canal. A second gutta-percha point is then introduced into the root canal and is deformed by means of a hook-shaped tool, known as a spreader, and condensed with the master point. This process is repeated until a homogeneous root canal filling is achieved. Excess coronal gutta-percha point is subsequently removed. Owing to the poor sealing properties of gutta-percha, for hermetic sealing of the root canal, it is essential to use an additional sealer, which is applied, for example, to the surface of the gutta-percha points.

In the above-described technique of lateral condensation, deformation of the gutta-percha point by the spreader can often not be effected satisfactorily, because the gutta-percha points, which are round in cross-section, elude deformation by the manually guided spreader. This means that a satisfactory lateral condensation and homogeneous filling of the root canal cannot always be ensured. That is, an ideal end result of the root canal filling can be achieved only with a comparatively large amount of time and not least assumes a corresponding dexterity of the operator.

With conventional methods for filling the root canal system using gutta-percha points, in particular, the technique of lateral condensation, to avoid irritation of the periapical tissue by filling material, it is often indicated to prepare what is called an apical stop. That is, to create a defined end to the usually conical canal configuration. Complete filling of the root canal with gutta-percha can often be done only with difficulty, owing to the small available space.

Furthermore, with customary methods of introducing gutta-percha into the root canal, trapped air or excess sealer can give rise to significant problems, which can mean that the outcome of the root canal treatment is not as successful as desired. When using customary gutta-percha points, there is also no guarantee that sufficient sealer will be introduced into the dentine tubules to ensure a complete occlusion and as a result prevent the ingress of fluids and germs.

Thus, there is a need for gutta percha points having superior qualities which overcomes or mitigates the problems and disadvantages of the previous gutta percha points. The present invention has as its objectives meeting these and other needs.

### SUMMARY OF THE INVENTION

This invention involves a gutta-percha point for filling a root canal system which tightly occludes the root canal laterally and vertically, has a stable volume, does not irritate the periapical tissue and does not shrink in the root canal.

In a first aspect of the present invention there is provided a gutta-percha point for filling a tooth root canal system having an elongated body having a conical region and tapering to an apical region terminating in a point; and a plurality of deformable protrusions selected from the group consisting of a barb, bump, lug, and circumferential ring formed on a longitudinal surface of the gutta-percha point. The protrusions deform on contact with the root canal wall to ensure complete contact with a root canal and a sealer and the protrusions have a thickness appropriate to achieve a desired thickness of the sealer. The deformable protrusions are constructed in a form of a helical winding on the longitudinal surface of the gutta-percha point.

In another aspect of the invention, the size and/or strength the deformable protrusions changes along the longitudinal axis.

In another aspect of the invention, the gutta-percha point has at least one portion having a cross-sectional area with a non-round circumference, wherein the cross-sectional area denotes a section through the gutta-percha point running perpendicular to the direction of the point. The cross-sectional area may be cut perpendicularly to the direction of the point.

In another aspect, the gutta-percha point has a plurality of portions, at least one portion having a cross-sectional area with a circumferential form that is different from the circumferential form of the cross-sectional area of a different portion.

In another aspect, the gutta percha point has a cross-sectional area with a non-round circumference has a circumference in the form of a closed polyline.

In another aspect, the surface of the gutta-percha point has a different roughness in different portions.

In another aspect, the surface of the gutta-percha point has at least one, pattern-form three-dimensional structure. The pattern-form three-dimensional structure may be a honeycomb structure.

In another aspect, different portions the gutta-percha point have different three-dimensional structures.

In yet another aspect, the gutta-percha point possesses at least one channel in one direction parallel to the point. The channel may be in the form of a channeled recess in the surface of the point.

In yet another aspect, the gutta-percha point has at least one structure running parallel to the direction of the point for reinforcing the gutta-percha point.

In yet another aspect, the invention is directed to a method for the manufacture of a gutta-percha point for filling a tooth root canal system, where a plurality of deformable protrusions selected from the group consisting of a barb, bump, lug, or circumferential ring are formed on a longitudinal surface of the gutta-percha point, the method comprising: casting liquid gutta-percha in a mold to produce a gutta-percha casting; and solidifying the gutta-percha casting to produce the gutta-percha point.

In yet another aspect, the invention is directed to a method for the manufacture of a gutta percha point for filling a root canal system, where a plurality of deformable protrusions selected from the group consisting of a barb, bump, lug, or circumferential ring are formed on a longitudinal surface of the gutta-percha point, the method comprising: casting liquid gutta-percha in a mold which is a negative impression of a positive impression of a tooth root canal system. Further, the liquid gutta-percha may be injection molded.

In yet another aspect, the produced gutta-percha point comprises a plurality of deformable protrusions on a surface of the gutta-percha point and the protrusions are deformable on contact with the root canal wall to ensure complete contact with a root canal and a sealer; and the protrusions have a thickness appropriate to achieve a desired thickness of the sealer.

In yet another aspect, a method for the manufacture of a gutta-percha point for filling a tooth root canal system, wherein a plurality of deformable protrusions selected from the group consisting of a barb, bump, lug, or circumferential ring are formed on a longitudinal surface of the gutta-percha point, has the additional steps of material-removing of a solid gutta-percha blank to produce the gutta-percha point. The gutta-perch blank may be milled.

In yet another aspect, the invention is directed to a method for the manufacture of a gutta-percha point for filling a tooth root canal system, wherein a plurality of deformable protrusions selected from the group consisting of a barb, bump, lug, or circumferential ring are formed on a longitudinal surface of the gutta-percha point, having the additional steps of three-dimensionally measuring the tooth root canal system and the gutta-percha point is molded in a mold corresponding to and complementary with the tooth root canal system.

In yet another aspect, the invention is directed to a method for the manufacture of a gutta-percha point for filling a tooth root canal system, wherein a plurality of deformable protrusions selected from the group consisting of a barb, bump, lug, or circumferential ring are formed on a longitudinal surface of the gutta-percha point, the method comprising: non-material-removing of a solid gutta-percha blank to produce the gutta-percha point. The gutta-percha blank may be pressed.

In yet another aspect, the method involves a gutta-percha blank, which comprises gutta-percha and at least one material other than gutta-percha, and is subjected to non-material-removing processing.

In yet another aspect, the method involves measuring three-dimensionally the tooth root canal system and the gutta-percha point is molded in a mold corresponding to and complementary with the tooth root canal system.

The present invention is also directed to a gutta-percha point manufactured by the method described herein.

It is understood that gutta-percha points can be commercially obtained in a variety of forms. In the present invention, the term “gutta-percha point” or “gutta-percha tip” means in particular a point or a tip for filling a tooth root canal system and comprising gutta-percha, gutta-percha being a known natural substance on a polyisoprene basis obtained from tree resins. Apart from gutta-percha, the gutta-percha point or gutta-percha tip (hereinafter called gutta-percha point) can contain customary additives, for example, inorganic substances, such as, for example, inorganic fillers, such as zinc oxide, X-ray contrast agents such as heavy metal salts, especially barium sulfate, or organic substances, such as waxes, for example. Normally, a gutta-percha point contains approximately 70% by weight of ZnO, approximately 10% by weight of BaSO₄ and approximately 1-4% by weight of waxes.

### BRIEF DESCRIPTION OF THE DRAWINGS

FIG. 1 shows a preferred embodiment of the gutta-percha point according to the invention, which has a plurality of protrusions in the form of bumps.

FIG. 2 shows a preferred embodiment of the gutta-percha point according to the invention, which has a plurality of protrusions in the form of barbs.

FIG. 3 shows a preferred embodiment of the gutta-percha point according to the invention, which has a plurality of protrusions in the form of lugs.

FIG. 4 shows a preferred embodiment of the gutta-percha point according to the invention, which has a plurality of protrusions in the form of circumferential rings having diameters that decrease in the apical direction.

FIG. 5 shows the protrusions of the gutta-percha point in the form of bumps helically wound about the gutta percha tip in a one rotational direction.

FIG. 6 shows a preferred embodiment of the gutta-percha point according to the invention, which has a protrusion in the form of a circumferential ring as well as a portion having a cross-sectional area with a round circumference and a portion having a cross-sectional area with a circumference in the form of a closed polyline.

FIG. 7 shows a further preferred embodiment of the gutta-percha point according to the invention, which has a protrusion in the form of a circumferential ring as well as a portion having a cross-sectional area with a round circumference and a portion having a cross-sectional area with a circumference in the form of a closed polyline.

FIG. 8 shows a preferred embodiment of the gutta-percha point according to the invention, which has a protrusion in the form of a circumferential ring as well as two portions having a cross-sectional area with a round circumference and two portions having a cross-sectional area with a circumference in the form of a closed polyline.

FIG. 9 shows a further preferred embodiment of the gutta-percha point according to the invention, which has a protrusion in the form of a circumferential ring as well as four portions having a cross-sectional area with a round circumference and two portions having a cross-sectional area with a circumference in the form of a honeycomb structure.

### DETAILED DESCRIPTION OF THE INVENTION

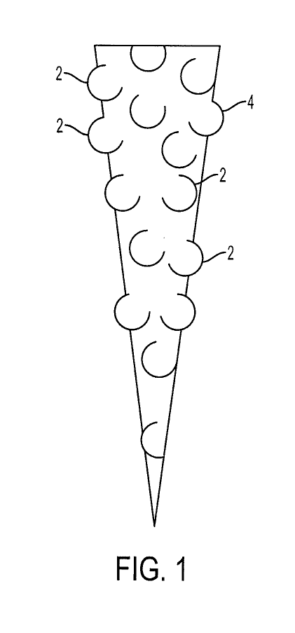

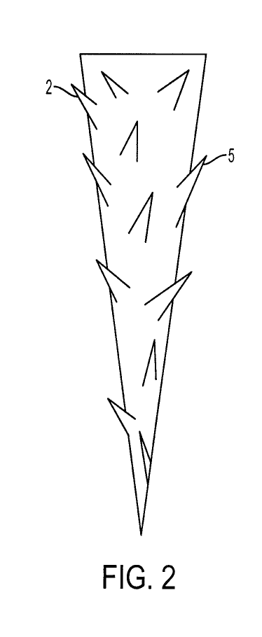

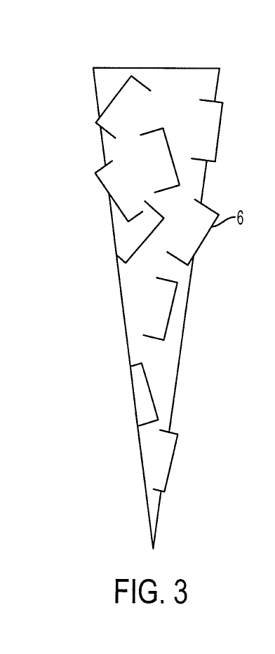

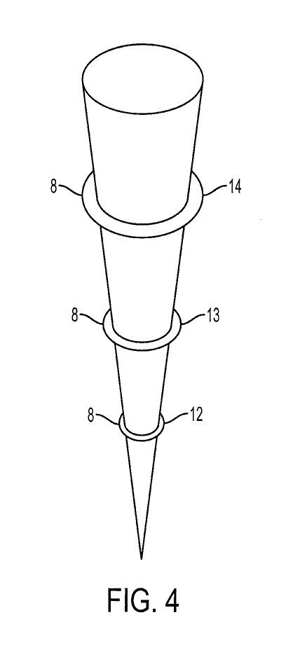

In accordance with a first embodiment of the invention, a gutta-percha point for filling a tooth root canal system is provided, which is characterized in that at least one protrusion (2) is formed on the surface of the gutta-percha point. Such a protrusion (2) is advantageously in the form of a bump (4), as shown in FIG. 1, a barb (5), as shown in FIG. 2, a lug (6), as shown in FIG. 3, or a circumferential ring (8), as shown in FIG. 4. This prevents the gutta-percha points, for example, from rolling out of position when the tooth root canal system is being filled. Since the protrusions deform on contact with the root canal wall, and establish a two-dimensional contact with it, a larger contact surface is thus provided, which prevents accidental movement or even dislodgement of the gutta-percha point from the root canal. Customary gutta-percha points have the disadvantage that they make poor contact with the root canal and with the sealer. Thus, with customary gutta-percha points manipulations at the coronal end of a gutta-percha point inserted in a root canal, for example to shorten the point or filling for the insertion of a post, cause the gutta-percha point in the root canal to move or become dislodged therefrom. A protrusion (2) improves the bond between gutta-percha point and sealer and between gutta-percha point and dentine in an advantageous manner. Moreover, through a given thickness of the protrusion, a desired thickness of the sealer layer can be set. A sealer can also be transported further into the root canal by the protrusions and be condensed in the root canal, which not only leads to an advantageous filling up of the root canal but also to displacement of the sealer into dentine tubules, the effect being that these are advantageously occluded, especially with respect to liquids and germs. Furthermore, a wedging, bracing or jamming of a plurality of gutta-percha points in the root canal is facilitated by at least one protrusion formed on the surface of each individual point, which also advantageously improves fixing of the points in the root canal.

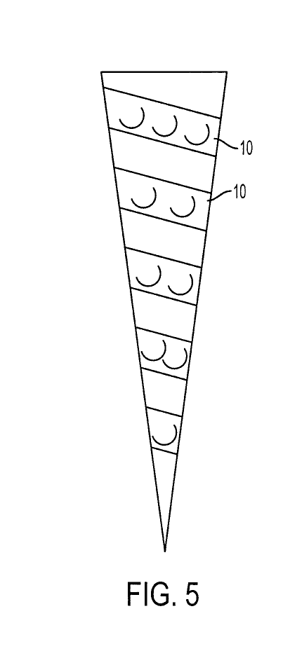

It is preferred that such protrusions are in the form of a helical winding (10) as shown in FIG. 5. By helical winding, it is understood to mean a winding in which the deformable protrusions advance along a helical path, not necessarily at a constant angle. Helical winding is characterized by a plus and minus winding angle as measured from the rotational axis. The angle may be anywhere from about 25° C. to 85° C. to the axis of rotation and the winding is along the longitudinal axis. The helical winding may be in one or more rotational direction (e.g. clockwise) from either the tip or opposite end along the longitudinal axis to the opposite end.

It is understood that there may be multiple helical windings in the same or opposite rotational direction so that the convolutions of the helical windings cross each other. That is, cross-helical windings where the winding is rotated in the opposite direction from a first winding. In a preferred embodiment illustrated in FIG. 5, the helical winding (10) of the protrusions is clockwise. In particular, helical winding ensures that the gutta-percha point is fixed in the root canal, because the helical windings are distorted and create a large contact area with the root canal wall. It is further understood that the protrusions may be wound circumferentially, or braided, as is understood to one skilled in the art, or in any other manner.

Preferably, a plurality of identical or different protrusions are provided at the same time on the surface of a gutta-percha point according to the invention. Several protrusions on the surface of a gutta-percha point can also have different sizes or strengths. Preferably, the relative size or strength of a plurality of protrusions on the surface of a gutta-percha point changes along the longitudinal axis thereof, that is to say, towards the apical end and the coronal end of the gutta-percha point. This is illustrated at FIG. 4 where the gutta-percha point has, a relatively thin circumferential ring (12) in the apical region, a thicker ring (13) in the middle region and an even thicker ring (14) in the coronal region.

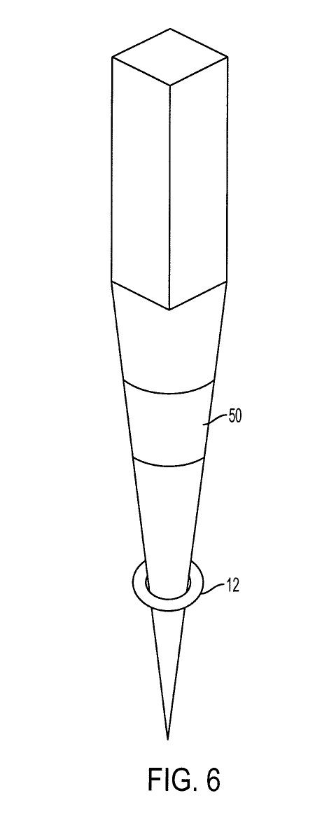

In a second preferred embodiment of the gutta-percha point of the present invention, at least one portion has a cross-sectional area with a non-round (non-circular) circumference. In other words, the gutta-percha point has at least one portion of a non-round cross-section by which the rolling property of the gutta-percha point is eliminated or at least reduced. This is shown in FIGS. 6-9. The expression “cross-sectional area”, as used here, describes preferably a section through the gutta-percha point running perpendicularly to the direction of the point. According to a preferred embodiment, the gutta-percha point has an angular form.

In another preferred embodiment, the gutta-percha point can comprise a plurality of portions in the direction of the point, at least one portion having a cross-sectional area having a circumferential form that differs from the circumferential form of the cross-sectional area of a different portion. Thus, the gutta-percha point can have, for example, apical cross-sectional areas of a circular cross-section. In a three-dimensional view, this can correspond to a conical form of the gutta-percha point in this region. Furthermore, the gutta-percha point can have coronal cross-sectional areas with a non-round, for example, angular circumference as shown in FIG. 6. In this way, the rolling property of the gutta-percha points in the non-apical portions of the tooth root canal system, in which the volume of the cavity is relatively large, can advantageously be eliminated or at least reduced. The root canal itself is generally not of round cross-section, so that the effect of a filling using a gutta-percha point of non-round cross-section is that the root canal is advantageously filled up.

The terms “apical” and “coronal”, as used here, refer to the arrangement of the gutta-percha point in the tooth root canal system.

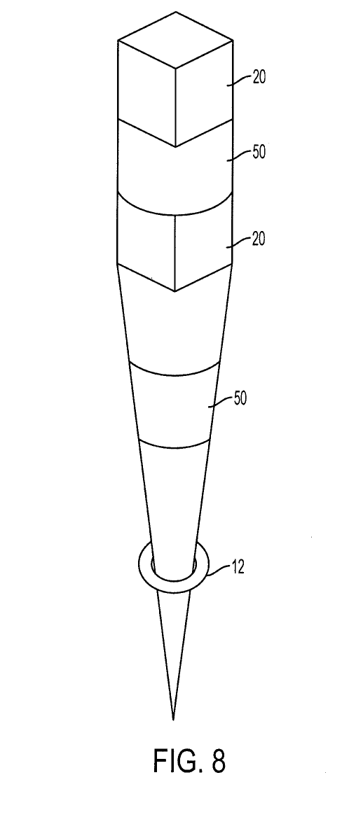

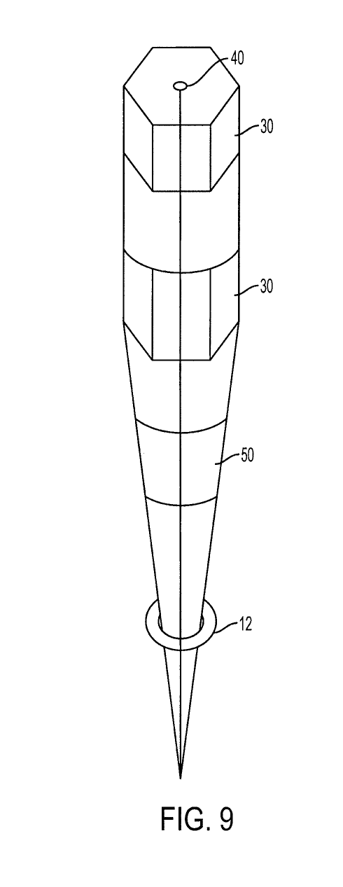

In a further exemplary embodiment, portions having cross-sectional areas with a round (circular) circumference and non-round (non-circular) circumference can be arranged alternately. This is shown in FIGS. 8 and 9.

According to the invention, it is preferred that the circumference of the cross-sectional area is partially or completely in the form of a closed polyline, that is to say, straight lines connected to one another, which merge into one another at a knee point. The knee points between the straight lines correspond in the three-dimensional form to edges of the surface of the gutta-percha point extending in the direction of the point, and correspond to the corners of an angular circumference of the cross-sectional area of the gutta-percha point. Owing to the edges, such a construction of the gutta-percha point is especially advantageous to prevent the gutta-percha point from rolling out of position as the tooth root canal system is being filled, and allows a gutta-percha point to be fixed properly in the root canal. At the same time, the flat faces of such a construction of the gutta-percha point have the advantage that several points can be fixed especially well against one another with a large contact area, for example, in the case of lateral condensation. Furthermore, the flat faces allow the space of the root canal to be properly filled by the gutta-percha points, since two gutta-percha points can be joined tightly with one another via a common coplanar, even face, that is, with no void between them. Such gutta-percha points can also be wedged, braced or jammed together especially effectively. A further advantage of large flat surfaces is that owing to greater friction they do not slide as readily past other surfaces as smaller surfaces do. Thus, it is more difficult for the gutta-percha points to slide past each other, which prevents undesirable slippage of points that have already been positioned. Furthermore, large surfaces have the advantage that they close well even without condensation, which is advantageous with regard to a good occlusion of the root canal.

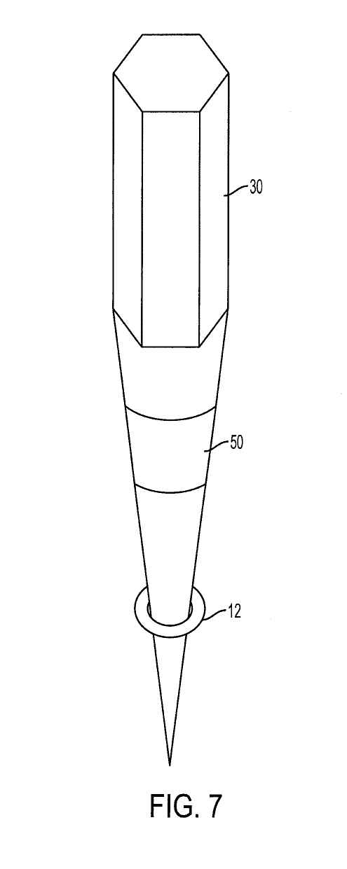

In accordance with a third embodiment of the invention, which can be combined in particular with the first and/or second embodiment of the invention, the surface of the gutta-percha point has a different roughness in different portions to reduce the rolling properties of a gutta-percha point. The gutta-percha point can accordingly advantageously be less rough, for example, in the apical region of the tooth root canal system, than in the non-apical region of the tooth root canal system. To increase the roughness of the surface of the gutta-percha point, at least one, in particular pattern-form, three-dimensional structure (20) can be formed on the surface of the gutta-percha point. Pattern-form three-dimensional structures are defined by regularly repeated structural elements, which are present, for example, in the form of depressions or bulges, whereas in the case of irregular three-dimensional structures the structural elements are arranged randomly. Such a three-dimensional structure to increase the roughness of the surface of the gutta-percha point is preferably present in the form of one or more honeycomb structures (30). FIG. 7 is directed to a gutta percha point having one honeycomb structure. FIG. 9. illustrates a gutta percha point having two honeycomb structures (30).

The term “honeycomb structure” as used herein refers to any hexagonal structure, pattern, or lattice or one resembling such a structure, pattern, or lattice. A honeycomb structure may refer to a hexagonal lattice, or a structure which is not a lattice.

Not only can the gutta-percha point be effectively prevented from rolling out of position by this means, but in addition the surface of the gutta-percha point can also be enlarged, so that condensation of the gutta-percha points is promoted. Furthermore, such a three-dimensional structure for increasing the roughness of the surface improves fixing of a gutta-percha point in the root canal, whereby in particular the master point can be apically fixed in order to ensure an advantageous occlusion of the root canal at the apex. Further advantages are evident for the wedging, bracing, jamming and/or interlocking, the effect being that gutta-percha points are fixed not only in the root canal but also against each another. A surface structure also advantageously renders it more difficult for several gutta-percha points to slide past one another or for a gutta-percha point to shift in the root canal. The bond between gutta-percha point and sealer is likewise advantageously improved by a three-dimensional surface structure.

In accordance with a fourth embodiment of the invention, which can be combined in particular with the first, second and/or third embodiment of the invention, the gutta-percha point is provided in one direction, for example, parallel to the point direction, with at least one through-channel (40). This is illustrated in FIG. 9. Such a through-channel can run, for example, completely within the gutta-percha point. Alternatively, the through-channel can be in the form of a channeled recess in the surface of the filling point. Air and/or liquids, especially the sealer, are advantageously able to escape from the root canal system through such through-channels, so that possible complications owing to any air remaining in the root canal system or owing to excess sealer are avoided. This significantly contributes to a positive treatment outcome.

Furthermore, the present invention allows for a quantity of sealer that ensures that the dentine tubules are completely and permanently occluded. Overfilling with sealer is thereby avoided, preventing escape of the sealer from the apex.

In accordance with a fifth embodiment of the invention, which can be combined in particular with the first, second, third and/or fourth embodiment of the invention, the gutta-percha point has on its surface at least one structure (50), running parallel to the direction of the point, such as a reinforcing rib to stiffen the gutta-percha point. Preferably, the structure is provided in the form of a reinforcing rib running parallel to the direction of the point. By means of such structures, introduction of a gutta-percha point into the tooth root canal system can be appreciably facilitated. Furthermore, such a structure advantageously improves both the rigidity and the strength of the gutta-percha point, while the plastic deformability of the gutta-percha point is maintained. Alternatively, the strength of the gutta-percha point can also be increased by incorporating a customary reinforcing material, such as reinforced fibers of glass or carbon as well as polymers.

The gutta-percha point according to the invention can advantageously be manufactured by casting of liquid gutta-percha in a mold to produce a gutta-percha casting, and by subsequent solidification of the gutta-percha casting to produce the gutta-percha point. Preferably, the process involves injection molding. More preferably, the liquid gutta-percha is poured into a mold that is a negative impression of a positive impression of a tooth root canal system. In other words, a cast is made of the tooth root canal system to produce the positive impression, for example, by introducing a silicone mass. Subsequently, this positive impression is used to make a negative impression. That is, a hollow mold, which corresponds to the cavity of the tooth root canal system is made. The negative impression is then plugged with liquid gutta-percha and solidified to produce the gutta-percha point. The gutta-percha point has a shape complementary to the cavity of the tooth root system.

Alternatively, the gutta-percha point can be produced by a material-removing processing of a solid gutta-percha blank. For example, the gutta-percha point is milled from a gutta-percha blank. In this connection, preferably the cavity of the tooth root canal system was previously three-dimensionally measured in a suitable manner and the gutta-percha point is milled from the gutta-percha blank using this measurement data. Using this method, similarly to casting of the gutta-percha point by means of a negative impression, a gutta-percha point having a shape complementary to the cavity of the tooth root canal system is produced.

Furthermore, the gutta-percha point can be manufactured by a non-material-removing processing of a solid gutta-percha blank. Here, a gutta-percha blank is pressed using a suitable pressing tool to shape the gutta-percha point. An additional advantage of this method is that it presents an opportunity to produce the gutta-percha points using different starting materials. Thus, for example, gutta-percha points can be manufactured having a surface of gutta-percha and a core of a material other than gutta-percha, especially flexible materials such as acrylates, silicones, polyethylenes, polypropylenes, metals, polyurethanes, thermoplastic elastomers, rubber-like compounds and the like. More preferably, the cavity of the tooth root canal system in this case was previously measured three-dimensionally in a suitable manner and using this measurement data the gutta-percha point is pressed from the gutta-percha blank. Similar to casting of the gutta-percha point by means of a negative impression, a gutta-percha point having a shape complementary to the cavity of the tooth root canal system is thereby produced by pressing.

Surprisingly, it was found that manufacture of a gutta-percha point with exactly defined three-dimensional surface structures and/or exactly defined protrusions is possible if such a structure and/or protrusion is either placed in the mold or applied subsequently.

While the present invention has been described and illustrated by reference to particular embodiments, those of ordinary skill in the art will appreciate that the invention lends itself to variations not necessarily illustrated herein. For this reason, reference should be made to the appended claims for purposes of determining the true scope of the present invention.

What is claimed is:

1. A gutta-percha point for filling a tooth root canal system comprising:
an elongated body having a conical region and tapering to an apical region terminating in a point; and
a plurality of deformable protrusions selected from the group consisting of a barb, bump, lug, and circumferential ring formed on a longitudinal surface of the gutta-percha point; wherein said protrusions deform on contact with the root canal wall to ensure complete contact with a root canal and a sealer; and wherein said protrusions have a thickness appropriate to achieve a desired thickness of the sealer.

2. The gutta-percha point of claim 1, wherein the deformable protrusions are constructed in a form of a helical winding on the longitudinal surface of the gutta-percha point.

3. The gutta-percha point of claim 1, wherein the size and/or strength the deformable protrusions changes along the longitudinal axis.

4. The gutta-percha point of claim 1, wherein the gutta-percha point has at least one portion having a cross-sectional area with a non-round circumference, wherein the cross-sectional area denotes a section through the gutta-percha point running perpendicular to the direction of the point.

5. The gutta-percha point of claim 1, wherein the gutta-percha point has a plurality of portions, at least one portion having a cross-sectional area with a circumferential form that is different from the circumferential form of the cross-sectional area of a different portion.

6. The gutta-percha point of claim 1, wherein the gutta percha point has a cross-sectional area with a non-round circumference has a circumference in the form of a closed polyline.

7. The gutta-percha point of claim 1, wherein the surface of the gutta-percha point has a different roughness in different portions.

8. The gutta-percha point of claim 1, wherein the surface of the gutta-percha point has at least one, pattern-form three-dimensional structure.

9. The gutta-percha point of claim 1, wherein different portions the gutta-percha point have different three-dimensional structures.

10. The gutta-percha point of claim 1, wherein the pattern-form three-dimensional structure is a honeycomb structure.

11. The gutta-percha point of claim 1, further comprising at least one channel in one direction parallel to the point.

12. The gutta-percha point of claim 11, wherein the channel is in the form of a channeled recess in the surface of the point.

13. The gutta-percha point of claim 1 wherein the gutta-percha point has at least one structure running parallel to the direction of the point for reinforcing the gutta-percha point.

14. The gutta-percha point of claim 4, wherein the cross-sectional area is cut perpendicularly to the direction of the point.

15. A method for the manufacture of a gutta-percha point for filling a tooth root canal system, wherein a plurality of deformable protrusions selected from the group consisting of a barb, bump, lug, or circumferential ring are formed on a longitudinal surface of the gutta-percha point, the method comprising: casting liquid gutta-percha in a mold to produce a gutta-percha casting; and solidifying the gutta-percha casting to produce the gutta-percha point.

16. The method according to claim 15 wherein the liquid gutta-percha is cast in a mold which is a negative impression of a positive impression of a tooth root canal system.

17. The method of claim 16 wherein the liquid gutta-percha is injection molded.

18. The method of claim 15 wherein the produced gutta-percha point comprises a plurality of deformable protrusions on a surface of the gutta-percha point; wherein said protrusions are deformable on contact with the root canal wall to ensure complete contact with a root canal and a sealer; and wherein said protrusions have a thickness appropriate to achieve a desired thickness of the sealer.

19. A method for the manufacture of a gutta-percha point for filling a tooth root canal system, wherein a plurality of deformable protrusions selected from the group consisting of a barb, bump, lug, or circumferential ring are formed on a longitudinal surface of the gutta-percha point, the method comprising: material-removing of a solid gutta-percha blank to produce the gutta-percha point.

20. The method of claim 19, wherein the gutta-percha blank is milled.

21. The method of claim 19 wherein the tooth root canal system is measured three-dimensionally and the gutta-percha point is molded in a mold corresponding to and complementary with the tooth root canal system.

22. A method for the manufacture of a gutta-percha point for filling a tooth root canal system, wherein a plurality of deformable protrusions selected from the group consisting of a barb, bump, lug, or circumferential ring are formed on a longitudinal surface of the gutta-percha point, the method comprising: non-material-removing of a solid gutta-percha blank to produce the gutta-percha point.

23. The method of claim 22, wherein the gutta-percha blank is pressed.

24. The method of claim 22, wherein a gutta-percha blank, which comprises gutta-percha and at least one material other than gutta-percha, is subjected to non-material-removing processing.

25. The method of claim 22, wherein the tooth root canal system is measured three-dimensionally and the gutta-percha point is molded in a mold corresponding to and complementary with the tooth root canal system.

26. A gutta-percha point manufactured by a method according to claim 15.

27. A gutta-percha point manufactured by a method according to claim 19.

28. A gutta-percha point manufactured by a method according to claim 22.
